(19) United States
(12) Patent Application Publication
(10) Pub. No.: US 2026/0100819 A1
(43) Pub. Date: Apr. 9, 2026

(54) ENCRYPTION KEY MANAGEMENT AND TRANSPARENT DECRYPTION

(71) Applicant: ALTR Solutions, Inc., Melbourne, FL (US)

(72) Inventors: Christopher Edward Struttmann, Indialantic, FL (US); Ethan Newman, Denton, TX (US); Ami Ikanovic, New York, NY (US)

(21) Appl. No.: 19/362,055

(22) Filed: Oct. 17, 2025

Related U.S. Application Data
(63) Continuation-in-part of application No. 18/755,059, filed on Jun. 26, 2024.
(60) Provisional application No. 63/510,205, filed on Jun. 26, 2023.

(51) Int. Cl. H04L 9/08; G06F 21/62; H04L 9/40

(52) U.S. Cl. CPC H04L 9/0822; G06F 21/6227; H04L 9/0866; H04L 9/40

(57) ABSTRACT

A system and method are provided for encryption key management, transparent decryption, and secure key sharing within a secure distributed storage environment. A master encryption key is generated for a user and encrypted using a wrapper key. Database keys are generated and encrypted using the master key, and then stored at a user-associated storage instance. In response to a query, the encrypted database key is decrypted using the master key and used to decrypt encrypted data. Masking policies may determine whether decrypted or encrypted data is returned to the user. Format-preserving encryption may be applied using a tweak value. Encrypted keys may be securely shared across independent encryption domains by re-encrypting under a temporary session master key. At no point is raw key material exposed to untrusted systems. The techniques improve key lifecycle security, enable policy-based access, and support multi-tenant data environments such as cloud-hosted data warehouses.

### CROSS-REFERENCE TO RELATED APPLICATIONS

This patent application is a continuation-in-part of U.S. Non-Provisional patent application Ser. No. 18/755,059, titled “ENCRYPTION KEY MANAGEMENT AND TRANSPARENT DECRYPTION,” filed 26 Jun. 2024. U.S. Non-Provisional patent application Ser. No. 18/755,059 claims benefit to provisional application 63/510,205 filed Jun. 26, 2023, titled ENCRYPTION KEY MANAGEMENT AND TRANSPARENT DECRYPTION. The entire contents of the aforementioned patent filings are hereby incorporated by reference for all purposes.

### BACKGROUND

### 1. Field

The present disclosure relates generally to databases and, more specifically, to encryption key management for encrypting data in a database or a data warehouse and providing transparent decryption when querying the data.

### 2. Description of the Related Art

Databases take a variety of forms. Generally, the term “database” refers to an organized collection of data or the system by which access to such data is afforded, depending on the context. Examples include relational databases, such as those first described in the seminal paper “A Relational Model of Data for Large Shared Data Banks” (Codd, Edgar F. (1970), Communications of the ACM. 13 (6): 377-387). More recent examples include object-oriented databases and document-oriented databases. Databases generally include a database management system by which users and other applications access the database, and in some cases, the term “database” is used to refer to this outward facing component, e.g., when referring to operational features of the database.

In many cases, the security and integrity of the data in the database cannot be trusted. Often, an attacker who has penetrated a computer network will modify or exfiltrate records in a database that are intended to be confidential. Further, in many cases, the attacker may be a credentialed entity within a network, such as a rogue employee, making many traditional approaches to database security inadequate in some cases. Aggravating the risk, in many cases, such an attacker may attempt to mask their activity in a network by deleting access logs stored in datastores.

### SUMMARY

The following is a non-exhaustive listing of some aspects of the present techniques. These and other aspects are described in the following disclosure.

Some aspects include a process including: creating, with one or more processors, a master encryption key for a user of a secure distributed storage having a plurality of databases; storing, with one or more processors, the master encryption key at a cybersecurity service provider key management system; generating, with one or more processors, a first database key, wherein the first database key is generated for encrypting and decrypting data in a first set of databases of the secure distributed storage or for encrypting and decrypting a first set of types of data that is stored across a set of databases of the plurality of databases; encrypting, with one or more processors, the first database key with the master encryption key thus providing a first encrypted database key; storing, with one or more processors, the first encrypted database key at a secure distributed storage instance for the user at the secure distributed storage; and encrypting, with one or more processors, the master encryption key with a wrapper key that is stored at the cybersecurity service provider key management system or another key management service.

Some aspects include a process including: receiving, with one or more processors, a query for a set of data from a user of a secure distributed storage having a plurality of databases, wherein data from the set of data is stored across a set of databases of the plurality of databases and is encrypted by a first encrypted database key stored at a secure distributed storage instance for the user at the secure distributed storage; providing, with one or more processors, a request to a cybersecurity service provider key management system for an encrypted master encryption key that is stored at the cybersecurity service provider key management system and that is associated with the user, wherein the request causes the cybersecurity service provider key management system to obtain a wrapper key that is stored at the cybersecurity service provider key management system or another key management service and decrypt the encrypted master encryption key with the wrapper key to obtain a master encryption key; decrypting, with one or more processors and using the master encryption key, the first encrypted database key to obtain a first database key; decrypting, with one or more processors and using the first database key, the set of data that is associated with the first database key and that is included in the query; and providing, with one or more processors and in response to the query, the set of data to the user.

Some aspects include a process including: receiving, with one or more processors, a query for a set of data from a user of a secure distributed storage having a plurality of databases, wherein data from the set of data is stored across a set of databases of the plurality of databases and is encrypted by a first database key stored at a secure distributed storage instance for the user at the secure distributed storage; determining, with one or more processors and based on a masking policy, that the user has permission to view plaintext of a first portion of the set of data while not having permission to view plaintext of a second portion of the set of data; decrypting, with one or more processors and using the first database key, the first portion of the set of data; and providing, with one or more processors and in response to the query, the set of data to the user, wherein the first portion of the set of data is provided in plaintext while the second portion of the set of data is provided encrypted in cyphertext.

Some aspects include a tangible, non-transitory, machine-readable medium storing instructions that when executed by a data processing apparatus cause the data processing apparatus to perform operations including any of the above-mentioned processes.

Some aspects include a system, including: one or more processors; and memory storing instructions that when executed by the processors cause the processors to effectuate operations of any of the above-mentioned processes.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a logical and physical architecture block diagram that shows an example of an encryption key management system in which the present techniques may be implemented in accordance with some embodiments;

FIG. 2 is a block diagram illustrating an example of a client computing device of the encryption key management system of FIG. 1, in accordance with some embodiments of the present disclosure;

FIG. 3 is a block diagram illustrating an example of a cybersecurity provider computing device of the encryption key management system of FIG. 1, in accordance with some embodiments of the present disclosure;

FIG. 4 is a block diagram illustrating a secure distributed storage computing device 400 of the secure distributed storage in the encryption key management system of FIG. 1, in accordance with some embodiments of the present disclosure;

FIG. 5 is a flowchart that shows an example of a process that generates hierarchical keys used in the encryption key management system of FIG. 1, in accordance with some embodiments of the present disclosure;

FIG. 6 is a flowchart that shows an example of a process that uses keys in the encryption key management system to encrypt data in a secure distributed database of FIG. 1, in accordance with some embodiments of the present disclosure;

FIG. 7 is a flowchart that shows an example of a process that uses keys in the key management system to decrypt data in a secure distributed database of FIG. 1, in accordance with some embodiments of the present disclosure;

FIG. 8 is a block diagram of an example of a key encryption hierarchy for encrypting data in the secure distributed storage of FIG. 1 and during the processes of FIGS. 5-7, in accordance with some embodiments of the present disclosure;

FIG. 9 is a block diagram of an example of data encryption and decryption of data with transparent policy-based decryption in the secure distributed storage of FIG. 1 and during the processes of FIGS. 6-7, in accordance with some embodiments of the present disclosure;

FIG. 10 is a flowchart that shows an example of a process to share encrypted data between different entities in the encryption key management system of FIG. 1 by creating a key sharing session, in accordance with some embodiments of the present disclosure;

FIG. 11 is a sequence diagram that shows an example of the process of FIG. 10 to establish a key sharing session, share database keys, and tear down the key sharing session, in accordance with some embodiments of the present disclosure; and

FIG. 12 is a physical architecture block diagram that shows an example of a computing device by which the above techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of cybersecurity, encryption/decryption key management, and encryption key sharing. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Users of a secure distributed storage that includes a plurality of databases or a data warehouse service encrypt sensitive data in the secure distributed storage to add a layer of protection against bad actors. These users want to encrypt and decrypt their data but do not want the overhead of managing encryption keys. When dealing with encryption key management, the user often opts to use third-party solutions to manage their keys. This introduces the need to build a solution to access and manage those keys to be able to use them in the encryption and decryption process. Building a solution to access and manage those keys by the user is cumbersome and results in different solutions for each user.

The systems and methods of the present disclosure provide for encryption key management that includes an interface (e.g., a structured query language (SQL)) for managing encryption keys over individually encrypted data on a partitioned level. The encryption key management system may provide key management to each user that stores data in a relational database or other secure distributed storage. A database key may be a key that is stored on a secure distributed storage's user instance for a user or otherwise associated with the data that it encrypts. The database key may be generated for encrypting and decrypting user data stored in the secure distributed storage, which may be across a set of databases of a plurality of databases included in the secure distributed storage. A plurality of database keys may exist on the user's database instance. For example, a database key may be generated for each individual database in which the user has data stored. In other examples, the database key may be field-based in that the database key may be used as a key across databases for specific data. For example, a database key may be used for encrypting and decrypting social security numbers that are stored on a first set of databases of the plurality of databases while another database key may be used for encryption and decryption of credit card numbers stored on a second set of databases that may include some of the same databases as the first set. The database key may be used to encrypt plaintext data to cyphertext data and decrypt the cyphertext data to plaintext data. As such, the database key may be symmetrical and, in some embodiments, may not be asymmetrical. The encrypted database key(s) may be stored at a user's instance on the secure distributed storage (e.g., with the data or in a user key store).

The database key or database keys may be encrypted by a master key that is associated with the user. The master key may encrypt the plaintext of the database key to cyphertext. The master key may be generated by a key management service such Amazon Web Service Key Management Service (AWS KMS) and may be stored by a cybersecurity provider's instance with the key management service or at the cybersecurity provider's computing device. The master key may be encrypted by a wrapper key that may be stored on the cybersecurity service's instance with the key management service or may be provided by the user (e.g., bring your own key BYOK). The wrapper key may be generated by the key management service.

In various embodiment, the user's secure distributed storage instance or the data stored may include a database tweak that may include a generated tweak that is encrypted by the master_key. When the database_tweak is decrypted, it may be used as input to the encryption/decryption algorithm along with the database key. Database tweaks may be present in format preserving encryption (FPE) algorithms. In addition, the systems and method of the present disclosure may also define cybersecurity_provider_key_id as the identification string used to associate a master key and wrapper key to a user.

The encryption key management interface may support a set of functions that collectively facilitate the creation, decryption, and rotation of encryption keys and associated tweak values. In one embodiment, the interface includes a function for creating a database key, such as fpe_create_key( ), which generates a new encrypted database key and returns it to the caller. If no master key exists for the user or client at the time of invocation, a master key is automatically generated prior to the creation of the database key. A second function, fpe_create_tweak( ), may be used to generate a corresponding database tweak, which is used in format-preserving encryption algorithms such as FF3-1. Similar to the key creation function, if a master key does not yet exist, the system may generate one before producing the tweak.

The encryption key management interface may also include a decryption function, fpe_decrypt_key_tweak( ), which decrypts either a database key or tweak. This operation involves decrypting the user's master key using a wrapper key, and then applying the decrypted master key to obtain the plaintext version of the specified key or tweak. Additionally, the encryption key management interface may support key rotation through a function such as fpe_rotate_keys( ), which facilitates the replacement of the existing master key. During this process, a new master key is generated, and all existing database keys and tweaks are decrypted using the old master key (itself decrypted by the wrapper key). These values are then re-encrypted using the new master key, the new master key is encrypted with the wrapper key, and the old master key is securely deleted. This architecture supports dynamic, secure, and auditable key management operations within a distributed encryption system.

A cybersecurity_provider_key_id may be employed to associate a specific user or client with a corresponding master key. In some embodiments, the cybersecurity_provider_key_id is generated using a hashing function applied to a client identifier or reference string, thereby producing a unique identifier for use in key management operations. The encrypted database key may be generated by the cybersecurity provider using the client's master key, and then returned to the user. Once received, the encrypted database key may be stored within the user's designated database instance, such as a tenant-controlled data warehouse or structured storage system.

The database key, and in certain configurations, an associated database tweak, may be used as input parameters to a format-preserving encryption algorithm for the encryption and decryption of user data. In order to perform encryption or decryption operations, the user may invoke a decryption function, such as fpe_decrypt_key_tweak( ), which decrypts the encrypted database key or tweak using the user's master key. This approach enables secure, role-based access to encryption keys, while maintaining strong separation between the user environment and the underlying key management infrastructure.

The partition level may be described herein as a database but could be a schema, a table, a column, or other data storage structure. In various embodiments, the keys may be symmetric keys or may not be asymmetric keys. The secured distributed storage may store external functions, which may include user-defined functions that are stored and executed outside of the secure distributed storage. External functions may make it easier to access external application programming interface (API) services such as geocoders, machine learning models, and other custom code running outside of the database service. This feature eliminates the need to export and reimport data when using third-party services, significantly simplifying a data pipeline. In the key management system of the present disclosure, an external function may be used to make API calls to access the key management system associated with the cybersecurity provider from the secure distributed database. For example, a query to the secure distributed database to access encrypted data may be made by the user. An external function may be used to pass the query context to the cybersecurity provider to check policy permissions for the user and the cybersecurity provider may return to the database provider the level of access the user has for the data, as discussed below. Furthermore, the external functions may trigger key generation, wrapping, unwrapping, and rotation in the cybersecurity provider's backend. The results (e.g., encrypted databased keys or decrypted values) may be passed back to the secure distributed database for storage or immediate use. These operations would be extremely difficult (and risky) to implement directly in the secure distributed database using native SQL or UDFs. External functions make the entire process of secure, policy-aware encryption and decryption inside the secure distributed database safe and seamless by offloading sensitive logic to the cybersecurity provider's trusted infrastructure while keeping the user interaction simple and SQL-native.

In various embodiments of the present disclosure, users may encrypt sensitive data stored in secure distributed storage to add a layer of protection against bad actors. The user may make a query for the data when the user needs it. The cybersecurity provider may provide an automated policy engine that may provide a signal indicating a level of access during the query based on the policy created by the user. However, working with encrypted data is cumbersome. For example, a determination of when a user should have access to the plaintext data may need to be made, a user may require access to the decryption algorithm, a user may require access to the encryption keys, the user may be required to manually decrypt the data, or other issues that would be apparent to one of skill in the art in possession of the present disclosure.

Thus, the systems and methods of the present disclosure may also provide transparent decryption to address these issues. Transparent decryption may allow users to see encrypted or decrypted data based on the policy set at the cybersecurity provider platform by accessing data as the user would if the data was not encrypted. In various embodiments, an external function or other mechanism is used to pass query context to a cybersecurity provider platform from the secure distributed storage. The cybersecurity provider platform may then return what level of access the user has. If the user has permission to see the data in plain text, the masking policy logic triggers decryption over the data, which may be according to the encryption key management, discussed above. The decrypted data is returned to the user in the query results. If the user does not have permission to see the plain text data, the encrypted data is returned to the user in the query results. The encrypted data may maintain the same format as the decrypted data but in cyphertext. This process is not visible to the user, the user simply queries data like they normally would and receives encrypted or decrypted data back.

In yet other embodiments, the present disclosure may also provide a system and method for secure cryptographic key sharing between distinct entities, each operating independent format-preserving encryption (FPE) environments with separate master key hierarchies. To enable the secure transfer of encrypted data across these distinct cryptographic domains, the present disclosure introduces a temporary, authenticated key sharing session that facilitates controlled key transformation without exposing plaintext key material.

In operation, a data producer (sender) initiates a session by requesting the creation of a secure context bound to a public reference identifier of a data consumer (receiver). This session is represented by a session token, which uniquely identifies the ephemeral key sharing instance. Once the receiver acknowledges the session using the token, a temporary session-specific master key is established within a secure key management service provided by the cybersecurity provider platform (e.g., ALTR).

The sender then supplies a set of encrypted data keys, which are initially encrypted under the sender's own FPE master key, to the secure key management service along with the session token. These keys are decrypted within the trusted environment and re-encrypted under the session master key, yielding intermediate shared keys. These shared keys are then transmitted to the receiver. The receiver, in turn, submits the shared keys and session token to the secure key management service, which decrypts the shared keys and re-encrypts them using the receiver's own FPE master key, producing keys compatible with the receiver's encryption domain.

This session-based transformation ensures that at no point is any raw key material exposed to either party or transmitted in plaintext. Additionally, the session may be time-bound or may be explicitly closed by either party, after which all re-encryption operations associated with the session are disabled. This design ensures confidentiality, integrity, and access isolation in the context of cross-tenant encrypted data sharing, and is particularly suited for multi-tenant cloud data environments such as Snowflake or other secured distributed storage providers.

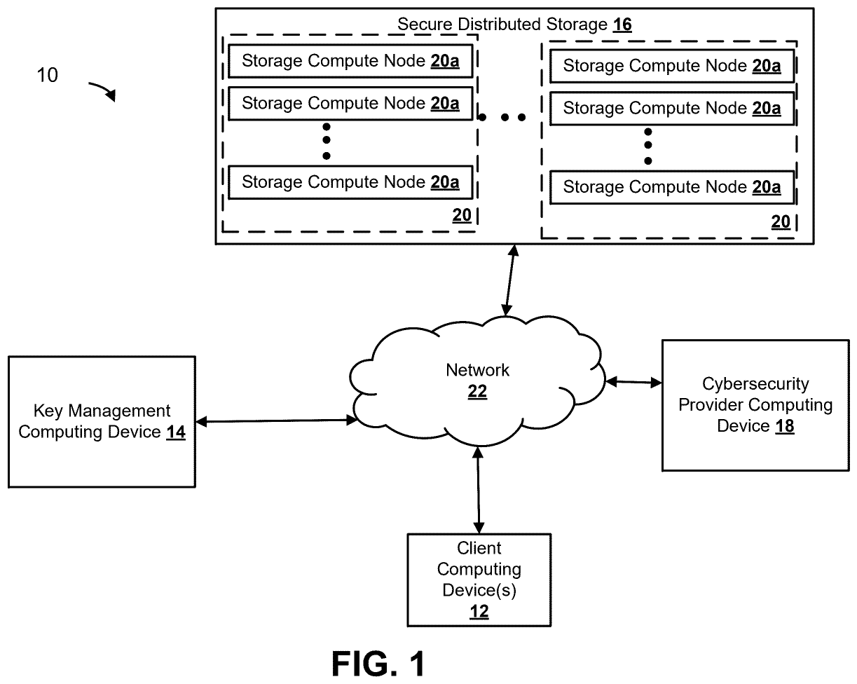

FIG. 1 illustrates an example of an encryption key management system 10 in which the present techniques may be implemented. In some embodiments, the encryption key management system 10 is a distributed computing environment implementing a client/server architecture, though other architectures are contemplated, including monolithic architectures executing on a single computing device. In some embodiments, the encryption key management system 10 includes client computing devices 12, a key management computing device 14, a secure distributed storage 16, a cybersecurity provider computing device 18, and a network 22, such as the Internet, by which these components may communicate.

In some embodiments, the client computing devices 12 are desktop computers, laptop computers, in-store kiosks, tablet computers, mobile phones, head-mounted displays, game consoles, set-top boxes or any other computing device that would be apparent to one of skill in the art in possession of the present disclosure, executing an operating system and a web browser or native application in which the described user interfaces are presented. One client computing device 12 is shown, but embodiments may support substantially more concurrent sessions, e.g., more than 100, or more than 1,000 geographically distributed sessions around the US or the world.

In some embodiments, the key management computing device 14 is a nonblocking web server or application program interface server configured to service multiple concurrent sessions with different client computing devices 12, for example, implementing a model-view-controller architecture or other design. In some embodiments, the key management computing device 14 may dynamically generate assets, markup language instructions, and scripting language instructions responsive to requests from client computing devices 12 to send user interfaces to, or update user interfaces on, those client computing devices 12. The user interface may evolve over time (e.g., in a web application), in some cases, displaying new resources (e.g., images and other data) sent from the key management computing device 14 responsive to user inputs to the user interface. In various embodiments the key management computing device 14 may provide cloud services such as Amazon Web Services (AWS) key management service (KMS) for generating and storing encryption keys. As such, the cybersecurity provider of the cybersecurity provider computing device 18 may have a key management service instance at the key management computing device 14.

In some embodiments, the cybersecurity provider computing device 18 is a nonblocking web server or application program interface server configured to service multiple concurrent sessions with different client computing devices 12, for instance implementing a model-view-controller architecture or other design. In some embodiments, the cybersecurity provider computing device 18 may dynamically generate assets, markup language instructions, and scripting language instructions responsive to requests from client computing devices 12 to send user interfaces to, or update user interfaces on, those client computing devices 12. The user interface may evolve over time (e.g., in a web application), in some cases, displaying new resources (e.g., images and other data) sent from the cybersecurity provider computing device 18 responsive to user inputs to the user interface. As discussed above, the cybersecurity provider computing device 18 may have an instance on a key management computing device 14 and may be integrated with the secure distributed storage 16 to provide user instances of a secure key management service platform.

In some embodiments, the secure distributed storage 16 may include a plurality of data centers 20 each having a plurality of storage compute nodes 20a that store at least portion of the data accessed with the client computing devices 12, in some cases with pointers therebetween stored in one or more of the storage compute nodes 20a. In some embodiments, as described below, data may be stored in a manner that abstracts away the secure distributed storage 16 from a workload application through which the data is accessed (e.g., read or written). In some embodiments, data access operations may store or access data in the secure distributed storage 16 with a workload application that is not specifically configured to access data in the secure distributed storage 16, e.g., one that is configured to operate without regard to whether the secure distributed storage 16 is present, and for which the storage of data in the secure distributed storage 16 is transparent to the workload application storing content in the secure distributed storage 16.

Content stored in the secure distributed storage 16 may be created or accessed with a variety of different types of applications, such as monolithic applications or multi-service distributed applications (e.g., implementing a microservices architecture in which each service is hosted by one of the client computing devices 12). Examples include email, word processing systems, spreadsheet applications, version control systems, customer relationship management systems, human resources computer systems, accounting systems, enterprise resource management systems, inventory management systems, logistics systems, secure chat computer systems, industrial process controls and monitoring, trading platforms, banking systems, and the like. Such applications that generate or access content in the secure distributed storage 16 for purposes of serving the application's functionality are referred to herein as “workload applications,” to distinguish those applications from infrastructure code by which the present techniques are implemented, which is not to suggest that these bodies of code cannot be integrated in some embodiments into a single workload application having the infrastructure functionality. In some cases, several workload applications (e.g., more than 2, more than 10, or more than 50), such as selected among those in the preceding list, may share resources provided by the infrastructure code and functionality described herein.

In some embodiments, the secure distributed storage 16 may include a collection of data centers 20, which may be distributed geographically and be of heterogeneous architectures. In some embodiments, the data centers 20 may be various public or private clouds or on-premises data centers for one or more organization-users, such as tenants, of the computing environment 10. In some embodiments, the data centers 20 may be geographically distributed over the United States, North America, or the world, in some cases with different data centers more than 100 or 1,000 kilometers apart, and in some cases with different data centers 20 in different jurisdictions. In some embodiments, each of the data centers 20 may include a distinct private subnet through which computing devices, such as rack-mounted computing devices in the subnet communicate, for example, via wrap top-of-rack switches within a data center, behind a firewall relative to the network 22. In some embodiments, each of the data centers 20, or different subsets of the data centers 20, may be operated by a different entity, implementing a different security architecture and having a different application program interface to access computing resources, examples including Amazon Web Services™, Azure from Microsoft™, Rack Space™, and Snowflake™. Two different data centers 20 are shown, but embodiments are consistent with, and in commercial implementations likely to include, more data centers, such as more than five, more than 15, or more than 50. In some cases, the data centers may be from the same provider but in different regions.

In some embodiments, each of the data centers 20 includes a plurality of different hosts exposed by different computational entities, like microkernels, containers, virtual machines, or computing devices executing a non-virtualized operating system. Each host may have an Internet Protocol address on the subnet of the respective data center 20 and may listen to and transmit via a port assigned to an instance of an application described below by which data is stored in a distributed ledger. In some embodiments, each storage compute node 20a may correspond to a different network hosts, each network coast having a server that monitors a port, and configured to implement an instance of one of the below-described directed acyclic graphs with hash pointers implementing immutable, tamper-evident distributed ledgers, examples include block chains and related data structures. In some cases, these storage compute nodes 20a may be replicated, in some cases across data centers 20, for example, with three or more instances serving as replicated instances, and some embodiments may implement techniques described below to determine consensus among these replicated instances as to state of stored data. Further, some embodiments may elastically scale the number of such instances based on amount of data stored, amounts of access requests, or the like.

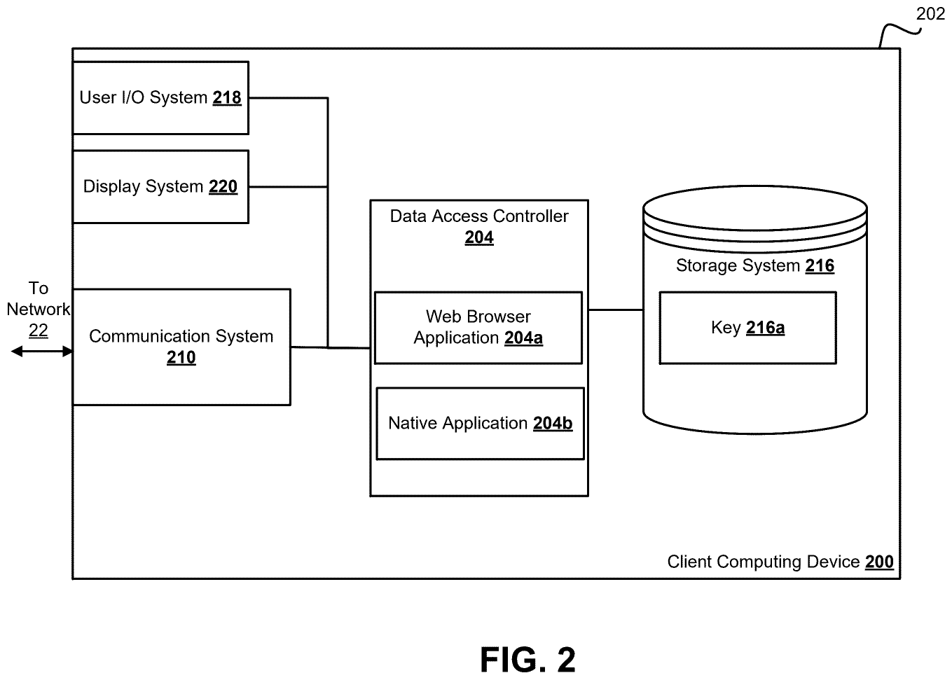

FIG. 2 illustrates an embodiment of a client computing device 200 that may be the client computing device 12 discussed above with reference to FIG. 1. In the illustrated embodiment, the client computing device 200 includes a chassis 202 that houses the components of the client computing device 200. Several of these components are illustrated in FIG. 2. For example, the chassis 202 may house a processing system and a non-transitory memory system that includes instructions that, when executed by the processing system, cause the processing system to provide a data access controller 204 that is configured to perform the functions of the data access controller or the user computing devices, discussed below. In the specific example illustrated in FIG. 2, the data access controller 204 is configured to provide one or more of a web browser application 204a or a native application 204b.

The chassis 202 may further house a communication system 210 that is coupled to the data access controller 204 (e.g., via a coupling between the communication system 210 and the processing system). The communication system 210 may include software or instructions that are stored on a computer-readable medium and that allow the client computing device 200 to send and receive messages through the communication networks discussed above. For example, the communication system 210 may include a communication interface to provide for communications through the network 22 as detailed above (e.g., first (e.g., long-range) transceiver). In an embodiment, the communication interface may include a wireless antenna that is configured to provide communications with IEEE 802.11 protocols (Wi-Fi), cellular communications, satellite communications, other microwave radio communications or communications. The communication system 210 may also include a communication interface (e.g., the second (e.g., short-range) transceiver) that is configured to provide direct communication with other user computing devices, sensors, storage devices, beacons, and other devices included in the encryption key management system 10 discussed above with respect to FIG. 1. For example, the communication interface may include a wireless antenna that configured to operate according to wireless protocols such as Bluetooth®, Bluetooth® Low Energy (BLE), near field communication (NFC), infrared data association (IrDA), ANT®, Zigbee®, Z-Wave® IEEE 802.11 protocols (Wi-Fi), or other wireless communication protocols that allow for direct communication between devices.

The chassis 202 may house a storage device (not illustrated) that provides a storage system 216 that is coupled to the data access controller 204 through the processing system. The storage system 216 may be configured to provide a key store 216a (e.g., wrapper keys, BYOK, session token), data, applications, messages, or instructions described in further detail below and used to perform the functions described herein. In various embodiments, the chassis 202 also houses a user input/output (I/O) system 218 that is coupled to the data access controller 204 (e.g., via a coupling between the processing system and the user I/O system 218). In an embodiment, the user I/O system 218 may be provided by a keyboard input subsystem, a mouse input subsystem, a track pad input subsystem, a touch input display subsystem, a microphone, an audio system, a haptic feedback system, or any other input subsystem. The chassis 202 also houses a display system 220 that is coupled to the data access controller 204 (e.g., via a coupling between the processing system and the display system 220) and may be included in the user I/O system 218. In some embodiments, the display system 220 may be provided by a display device that is integrated into the client computing device 200 and that includes a display screen (e.g., a display screen on a laptop/notebook computing device, a tablet computing device, a mobile phone, or wearable device), or by a display device that is coupled directly to the client computing device 200 (e.g., a display device coupled to a desktop computing device by a cabled or wireless connection).

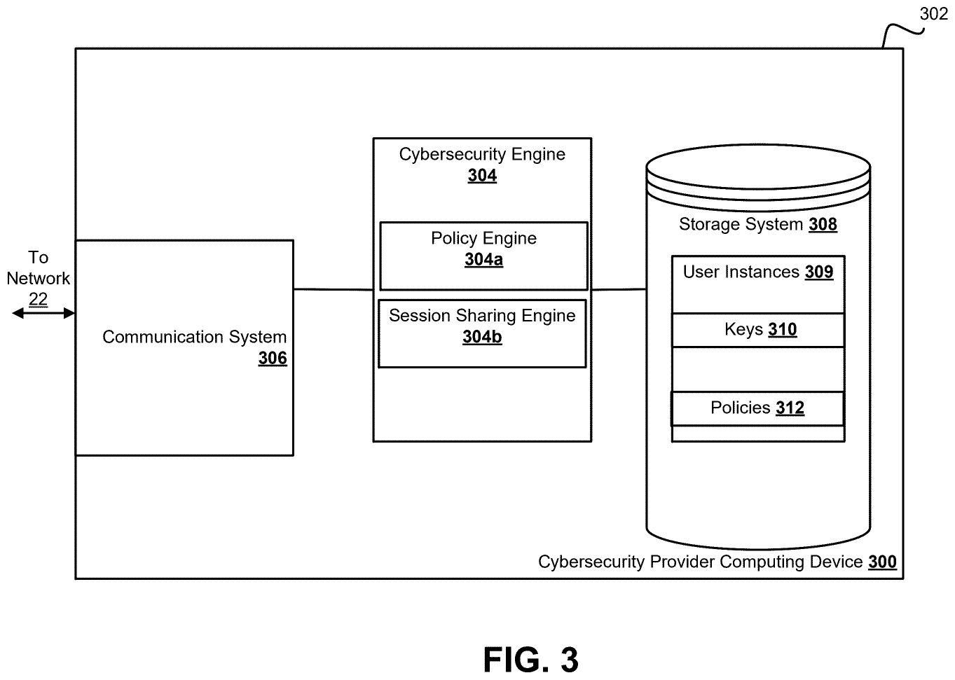

FIG. 3 depicts an embodiment of a cybersecurity provider computing device 300, which may be the cybersecurity provider computing device 18 discussed above with reference to FIG. 1. In the illustrated embodiment, the cybersecurity provider computing device 300 includes a chassis 302 that houses the components of the cybersecurity provider computing device 300, only some of which are illustrated in FIG. 3. For example, the chassis 302 may house a processing system (not illustrated) and a non-transitory memory system (not illustrated) that includes instructions that, when executed by the processing system, cause the processing system to provide a cybersecurity engine 304 that is configured to perform the functions of the cybersecurity engines or cybersecurity provider computing devices discussed below. Specifically, the cybersecurity engine 304 may perform the cybersecurity actions (e.g., key encryption/decryption, creation, and storage; policy management, shared key session management; or other cybersecurity functions discussed herein)., Specifically, the cybersecurity engine 304 may include the policy engine 304a that processes data requests and returns a policy for how a user is presented data that is requested. The cybersecurity engine 304 may include a session sharing engine 304b that may perform secure key sharing and sharing session creation discussed herein.

The chassis 302 may further house a communication system 306 that is coupled to the cybersecurity engine 304 (e.g., via a coupling between the communication system 306 and the processing system) and that is configured to provide for communication through the network 22 of FIG. 1 as detailed below. The communication system 306 may allow the cybersecurity provider computing device 300 to send and receive messages over the network 108 of FIG. 1. The chassis 302 may also house a storage device (not illustrated) that provides a storage system 308 that is coupled to the cybersecurity engine 304 through the processing system. The storage system 308 may be configured to store user instances 309 and configured to provide a key store 310 (e.g., wrapper keys, master keys) and policy sets 312 for each user instance 309. The storage system 308 may include other data or instructions to complete the functionality discussed herein. In various embodiments, the storage system 308 may be provided on the cybersecurity provider computing device 300 or on a database accessible via the communication system 306. The user instances 309 may be associated with a user instance 408b of the user at the secure distributed storage 16.

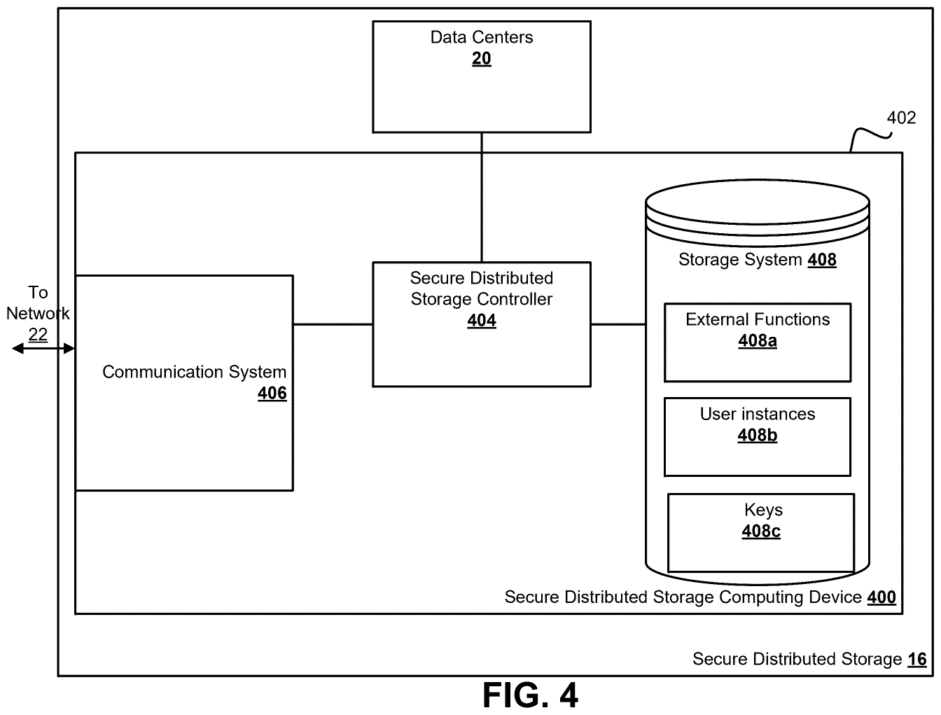

FIG. 4 illustrates an embodiment of a secure distributed storage computing device 400 that may be provided by the secure distributed storage 16 discussed above with reference to FIG. 1. In the illustrated embodiment, the secure distributed storage computing device 400 includes a chassis 402 that houses the components of the user computing device 400. Several of these components are illustrated in FIG. 4. For example, the chassis 402 may house a processing system and a non-transitory memory system that includes instructions that, when executed by the processing system, cause the processing system to provide a secure distributed storage controller 404 that is configured to perform the functions of the secure distributed storage controller or the secure distributed storage computing device, discussed below. For example, the secure distributed storage controller 404 may be a data platform provided by Snowflake®, headquartered in Bozeman, Montana, United States of America, that provides data storage, processing, and analytic solutions on a cloud infrastructure. The data platform may include multiple layers such as database storage, query processing and cloud services.

The chassis 402 may further house a communication system 406 that is coupled to the secure distributed storage controller 404 (e.g., via a coupling between the communication system 406 and the processing system). The communication system 406 may include software or instructions that are stored on a computer-readable medium and that allow the secure distributed storage computing device 400 to send and receive messages through the communication networks discussed above. For example, the communication system 406 may include a communication interface to provide for communications through the network 22 as detailed above. The chassis 402 may house a storage device (not illustrated) that provides a storage system 408 that is coupled to the secure distributed storage controller 404 through the processing system. The storage system 408 may be configured to store external functions 408a, data, applications, user instances 408b, encryption keys 408c (e.g., database keys in a keys store), or instructions described in further detail below and used to perform the functions described herein. While a specific example of a secure distributed storage computing device is illustrated, one of skill in the art in possession of the present disclosure will recognize that different configurations may be contemplated.

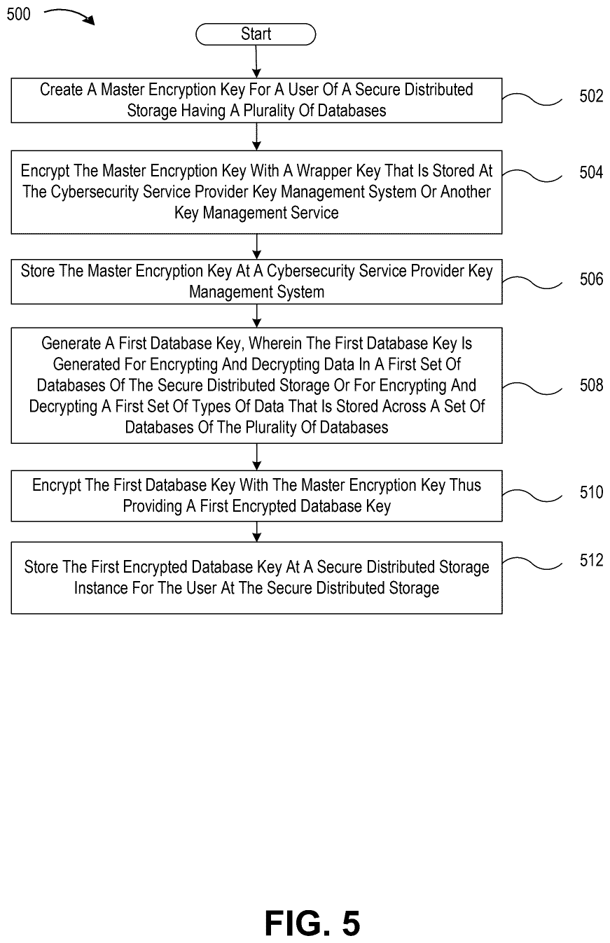

FIG. 5 illustrates a flowchart of a method 500, according to various embodiments. The method 500 may begin at block 502 where a master encryption key for a user of a secure distributed storage having a plurality of databases is created. In an embodiment, at block 502, the cybersecurity engine 304 of the cybersecurity provider computing device 300 may generate a master encryption key. The cybersecurity engine 304 may communicate with the key management computing device 14 to generate the master encryption key, which may be stored on an instance that the cybersecurity provider for the cybersecurity computing device 300 has on the key management computing device 14 of FIG. 1. For example, a command may be received to generate a master encryption key for the user.

In another example of master encryption key generation, a user may interact with an SQL interface provided by the secure distributed storage computing device 400. The user may request that a database key for data be created by calling an external function such as fpe_create_key( ) function. The external function may call an API of the cybersecurity engine 304 and if no master encryption key exists, the cybersecurity engine 304 may cause the key management computing device 14 to generate a master encryption key before generating the requested database key. Similarly, if an fpe_create_tweak( ) function is called for FF3-1 encryption, a master key may be generated before the database tweak. In FF3-1 and FF3 FPE encryption algorithms, tweaks may be used for further security of the data. A tweak may be an additional alphanumeric string input used alongside the plaintext and database key to enhance security for small domains. The tweak may make it more difficult for attackers to use statistical methods to break the encryption. Different tweak values may produce different outputs for the same database key and data. The original tweak value used for encryption is required to decrypt the data. In some embodiments, the tweak may be protected with the master encryption key. Once the master encryption key is generated, a key identifier may be used to associate the master encryption key to the user. In various embodiments, the key identifier may include an identification string that is generated using a hashing function and a user identifier.

The method 500 may proceed to block 504 where a master encryption key is encrypted with a wrapper key that is stored at the cybersecurity provider key management system or another key management service. In an embodiment, at block 504, the cybersecurity engine 304 may wrap or encrypt the master encryption key with a wrapper key. Prior to being stored or after generating and encrypting the database keys with the master encryption key (as discussed below), the master encryption key may be encrypted or wrapped with a wrapper key that is either provided by the user and stored at the client computing device 12/200 (e.g., bring your own key (BYOK) such as key 216a) or that is stored on the cybersecurity provider's instance on the key management computing device 14 of FIG. 1. In some embodiments, the wrapper key may generated for the user by the key management service of the key management computing device 14 such as AWS KMS. The wrapper key may be associated with the user via the key identifier that is used to associate the master encryption key to the user.

The method 500 may proceed to block 506 where the master encryption key is stored at a cybersecurity service provider key management system. In an embodiment, at block 506, the master encryption key generated may be stored at the user instance 309 of the cybersecurity provider computing device 300 or the user instance 408b on the secure distributed storage 16. In some embodiments, the master encryption key may be stored in cybersecurity service provider's instance at the key management service provided by the key management computing device 14 of FIG. 1.

The method 500 may proceed to block 508 where a database key is generated for encrypting and decrypting data in a set of databases of the secure distributed storage or for encrypting and decrypting a set of types of data that is stored across a set of databases of the plurality of databases. In an embodiment, at block 508, a database key may be generated for encrypting and decrypting data stored in the secured distributed storage 16. As discussed above, the user may request that a database key for data be created by calling an fpe_create_key( ) function. The cybersecurity engine 304 may receive the function call from the secure distributed storage computing device 400 and communicate with the key management service of the key management computing device 14 to generate the database key. Similarly, a tweak may be generated as well for FF3-1 encryption. As discussed above, the user may request that a database key for data be created by calling an fpe_create_tweak( ) function. The cybersecurity engine 304 may receive the function call and communicate with the key management service of the key management computing device 14 to generate the tweak. The database key and, in some embodiments, the tweak are used as input to the encryption algorithm (e.g., an FPE encryption algorithm) to encrypt and decrypt the data. In some embodiments, the database key may be associated with a type of data. For example, the database key may be associated with a set of telephone numbers, a set of social security numbers, a set of names, a set of addresses, a set of email addresses, a set of credit card numbers, a set of account numbers, or other data types that would be apparent to one of skill in the art in possession of the present disclosure. In other embodiment, the database key may be associated with a set of data that may have more than one type of data.

The method 500 may proceed to block 510 where the first database key is encrypted with the master encryption key, thus providing an encrypted database key. In an embodiment, at block 510, the cybersecurity engine 304 may encrypt the database key with the master encryption key that is associated with the user that requested the creation of the database key. The key identifier may be obtained from a user identifier and used to identify the master key. The master key is retrieved and decrypted (e.g., unwrapped) with the wrapper key, and then the master key is used only in memory to encrypt the database key.

The method 500 may then proceed to block 512 where the encrypted database key is stored at a secure distributed storage instance for the user at the secure distributed storage. In an embodiment, at block 512, the cybersecurity engine 304 may provide the encrypted database key to the secure distributed storage controller 404 via the network 22. The secure distributed storage controller 404 may store the database key at the user instance 408b for the user associated with the database key. Similarly, in embodiments, where a tweak is used, the cybersecurity engine 304 may provide the encrypted tweak to the secure distributed storage controller 404 via the network 22. The secure distributed storage controller 404 may store the tweak at the user instance 408b for the user associated with the tweak. In some embodiments, the encrypted database keys or tweaks may be associated with the data by links or pointers. In other embodiments, the encrypted databased keys or tweaks may be stored alongside or indexed to the data.

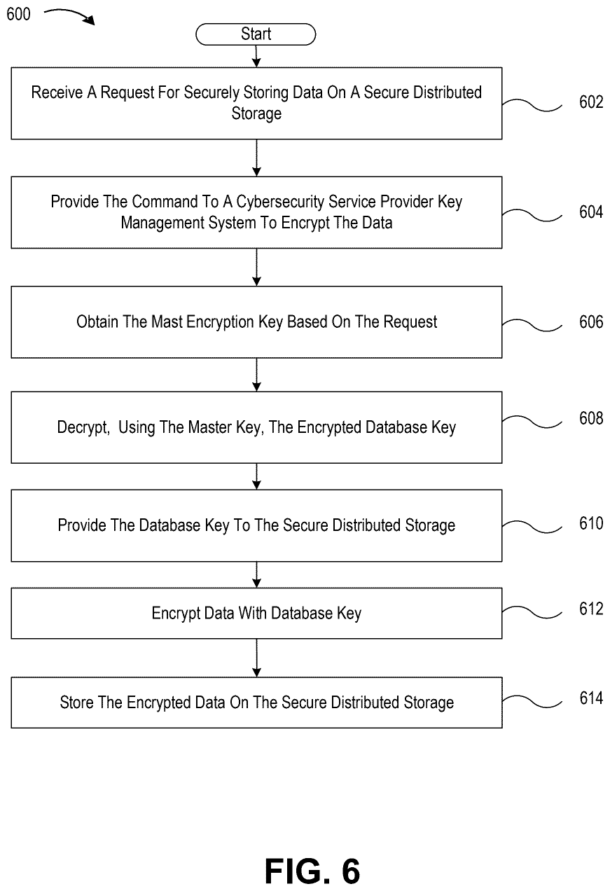

FIG. 6 illustrates a flowchart of a method 600 for encrypting data that is stored on secure distributed storage, according to various embodiments of the present disclosure. The method 600 may begin at block 602 where a command is received for securely storing data on a secure distributed storage. In an embodiment, at block 602, the secure distributed storage controller 404 may receive a request to store data on the secure distributed storage 16. The request may include a user identifier and the data that is to be stored. In some embodiments, the data may include various types of data (e.g., a set of telephone numbers, a set of social security numbers, a set of names, a set of addresses, a set of email addresses, a set of credit card numbers, a set of account numbers, or other data types that would be apparent to one of skill in the art in possession of the present disclosure). The request may identify whether the data is to be stored as a set with a particular database key or with various database keys associated with respective type of data (e.g., a database key for social security numbers and a different database key for credit card numbers). In other embodiments, policies 312 as to how the data is to be partitioned and encrypted may be stored at the secure distributed storage computing device 400 in the user instance 408 or at the user instance 309 at the cybersecurity provider computing device 300. Partitioning by key is often based on policy or key labels, not hardcoded in user requests. The association between data types and keys may be determined by policy enforcement logic, not only by user selection.

The method 600 may proceed to block 604 where the request to encrypt data is passed to the cybersecurity service provider. In an embodiment, at block 604, the secure distributed storage controller 404 may use an external function 408a to pass the request to the cybersecurity engine 304. As discussed herein, the external function may be a user-defined function that is stored and executed outside of the secure distributed storage controller 404. The external function may make it easier to access external API services running outside of the secure distributed storage controller 404 and may eliminate the need to export and reimport data using third-party services, thus simplifying data pipelines. As such, the external function may make an API call to the cybersecurity engine 304 and provide the request, any encrypted database keys associated with the request, a user identifier, a BYOK or other information that may be used to decrypt the encrypted database key. The encrypted database keys themselves may not be necessarily passed in every request. They may already reside in the storage system 308 and be referenced via key labels or metadata.

The method 600 may proceed to block 606 where the master encryption key is obtained based on the request. In an embodiment, at block 606, the cybersecurity engine 304 may obtain a master encryption key associated with a key identifier included in the request. The master encryption key may be stored and wrapped in the user instance 309 for the user. The wrapper key associated with the key identifier may be obtained and used to decrypt or unwrap the master encryption key. In other embodiments, database keys may have not been created for the data and the cybersecurity engine 304 may generate the database key or, if not created, generate the master key according to the method 500 of FIG. 5. Database key creation and master key generation can be triggered automatically as part of the FPE function call sequence (fpe_create_key, etc.), so the user may not explicitly request key creation.

The method 600 may proceed to block 608 where the encrypted database key is decrypted with the master encryption key. In an embodiment, at block 608, the cybersecurity engine 304 may decrypt the encrypted database key or keys with the master encryption key. The cybersecurity engine 304 may provide the master key and the encrypted database key as inputs into the encryption algorithm that was used to encrypt the database key(s). The encryption algorithm may output the decrypted database key. Similarly, an encrypted tweak may be decrypted with the master key.

The method 600 may proceed to block 610 where the database key is returned to the secure distributed storage. In an embodiment, at block 610, the database key may be returned to the secure distributed storage computing device 400. For example, in response to the API call via the external function, the cybersecurity engine 304 may return the one or more database keys used to encrypt the data to the secure distributed storage computing device 400. Likewise, if a database tweak was decrypted by cybersecurity engine 304, the database tweak may be returned to the secure distributed storage session of data storing.

The method 600 may proceed to block 612 where the data is encrypted with the database key. In an embodiment, at block 612, the secure distributed storage engine 404 may use an encryption algorithm with the database key to encrypt at least a portion of the data. Other database keys may encrypt other portions of the data. For example, one or more database keys may be used for a type of data while one or more other database keys may be used to encrypt another type of data. Associations between the database keys and the data may be stored at the secure distributed storage computing device 400. In some embodiments, a database key and a decrypted tweak may be used to encrypt the data using an FPE encryption algorithm (e.g., FF3-1). In some embodiments, the encryption of the data may be performed on a client application layer or by the secure distributed storage controller 404 via stored procedures or UDFs that have access to an encryption algorithm's libraries (e.g., FPE libraries). The plaintext keys or tweaks may never persist at the secure distributed storage system 400 as they may only be used transiently within memory during encryption of the data. Thus, when encryption is performed by the secure distributed storage engine, the plaintext database key/tweak is held only in volatile memory and never persisted. In some embodiments, the data may be encrypted by the database key by the cybersecurity engine 304 and the encrypted data may be passed to the secure distributed storage engine 404 for storage.

The method 600 may proceed to block 614 where the encrypted data is stored at the secure distributed storage. In an embodiment, at block 614, the encrypted data may be stored by the secure distributed storage engine 404 at the secure distributed storage 16. The encrypted data may be stored across various datacenters 20 and storage compute nodes 20a. Using an FPE algorithm, the result of the encryption in block 612 is cyphertext that retains the original format (e.g., fixed-length strings, digit-only fields), which may be written to a table provided by the secure distributed storage 16. Encrypted data written back to the storage layer may retain referential integrity with unencrypted tables.

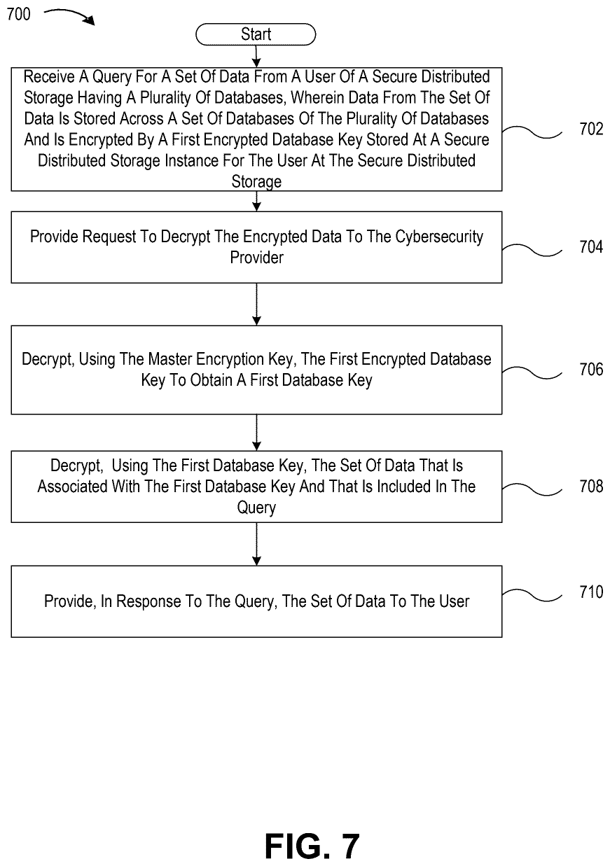

FIG. 7 illustrates a flowchart of a method 700 for decrypting data that is stored in secure distributed storage, according to various embodiments of the present disclosure. The method 700 may include block 702 where a query for a set of data is received from a user of a secure distributed storage. In an embodiment at block 702, the user, via the user computing device 12/200, may send a query to the secured distributed storage computing device 400 to obtain a set of data. For example, the user or an application on the client computing device 12/200 may run an SQL statement like “SELECT cybersecurityservice_fpe_decrypt_column(encrypted_value, encrypted_key, encrypted_tweak) FROM secure_table;.” Data from the set of data may be stored across a set of databases of the plurality of databases. The set of data may be encrypted and associated with one or more database keys that may be stored at a secure distributed storage instance for the user at the secure distributed storage computing device 400. As discussed above, the data may be encrypted by type, by user, other parameters, or a combination of parameters. The encrypted value, the encrypted key, and in some instances the encrypted tweak may be stored in columns of the same or related tables.

In some embodiments, the query may be made to the secure distributed storage computing device 400 for data from a table (e.g., SQL statement: SELECT ssn, name FROM customer_data;). The user or application making the query may or may not know whether the data is encrypted or not. The data or a portion of the data may be associated with a masking policy. The secure distributed storage controller 404 may call an external function 408a (e.g., cybersecurityservice_check_policy) to ask the policy engine 304a if the user associated with the request is authorized to view the decrypted data. The policy engine 304a may determine whether the user is authorized to access the data based on a user identifier, a user's role, a field or a resource the user is accessing, or other information associated with the data or user. If the user is permitted to view the data, the policy engine 304a may indicate the permission to the secure distributed storage controller 404. If the user is not permitted to view the data, the policy engine 304a may indicate the lack of permission to the secure distributed storage controller 404. The masking policy at the secure distributed storage controller 404 may return the encrypted value as-is (e.g., still in format-preserved ciphertext). If the user is authorized, then masking policy may cause the secure distributed storage controller 404 to proceed to block 704.

The method 700 may proceed to block 704 where a request to decrypt the data is provided to the cybersecurity provider computing device. In an embodiment, at block 704, the secure distributed storage controller 404 may use an external function 408a to pass the request to the cybersecurity engine 304 to decrypt the data. As discussed herein, the external function 408a may be a user-defined function that is stored and executed outside of the secure distributed storage controller 404. The external function 408a may make it easier to access external API services running outside of the secure distributed storage controller 404 and may eliminate the need to export and reimport data using third-party services, thus simplifying data pipelines. As such, the external function 408a may make an API call to the cybersecurity engine 304 and provide the request, any encrypted database keys or tweaks associated with the request, a user identifier, a BYOK, the encrypted data, or other information that may be used to decrypt encrypted database key.

In an embodiment, at block 704, the request may cause the cybersecurity engine 304 to obtain a wrapper key that is stored at the cybersecurity provider computing device 300 in the key store 310 or another key management service (e.g., key management computing device 14 (e.g., AWS KMS) or other cloud KMS service if BYOK is used) and decrypt the encrypted master encryption key with the wrapper key to obtain a master encryption key.

The method 700 may proceed to block 706 where the first encrypted database key is decrypted, using the master encryption key, to obtain a first database key. In an embodiment, at block 706, the cybersecurity engine 304 may decrypt the encrypted database key with the master key. Similarly, if an encrypted tweak is provided in the request, the encrypted tweak may be decrypted by the master key. The database key or the tweak may be in plaintext only within the cybersecurity provider computing device's 300 trusted memory and not stored.

The method 700 may proceed to block 708 where the set of data that is associated with the first database key and that is included in the query is decrypted, using the first database key. In an embodiment, at block 708, the cybersecurity engine 304 may include an encryption/decryption algorithm that was used to encrypt the data. The cybersecurity engine 304 may decrypt the encrypted data with the database key and encryption/decryption algorithm. In some embodiments, the tweak may also be used with the database key and the encryption/decryption algorithm to decrypt the encrypted data. For example, the cybersecurity engine 304 may use the decrypted database key and tweak to perform format-preserving decryption using an FPE algorithm (e.g., FF3-1). The data may be provided in its original plaintext form, maintaining the format and length constraints of the encrypted value.

The method 700 may proceed to block 710 where the set of data, requested in the query, is provided to the user. In an embodiment, at block 710, the cybersecurity engine 304 may provide the data identified in the request to the secure distributed storage controller 404. The secure distributed storage controller 404 may provide the data to the client computing device 200 in response to the request. All decrypted database keys, the master key, or any tweaks may be discarded from memory after the decryption operation.

In some embodiments, the system provides a method for securely rotating a master key associated with a client or tenant within the multi-tenant data security platform. The rotation process begins when a client computing device 12/200 initiates a master key rotation request, typically through a function call such as cybersecurityservice_fpe_rotate_keys( ). This request is executed within the secured distributed storage 16 such as a cloud-hosted data environment (e.g., Snowflake) and transmitted via a secure external function to the cybersecurity provider computing device 300.

Upon receiving the request, the cybersecurity engine 304 may identify the client through a unique identifier (e.g., cybersecurityservice_key_id) and retrieves the corresponding master key, which may be typically encrypted or “wrapped” using a higher-level key such as a wrapper key residing in the key management computing device 14 (e.g., AWS KMS) or in a BYOK model). The cybersecurity engine 304 may then decrypt the current master key using the wrapper key within its secure, isolated execution environment. Once the current master key is available in memory, the cybersecurity engine 304 generates a new cryptographically secure master key according to the master key generation discussed above. This new master key may be wrapped using the appropriate wrapper key to ensure it is protected before being stored or used in further operations.

The cybersecurity engine 304 may then proceed to locate all database encryption keys and associated tweak values that were originally encrypted using the old master key. For each such key or tweak, the cybersecurity engine 304 may perform a rewrapping process where the object is decrypted using the old master key and then re-encrypted using the new master key. This operation may be executed iteratively across a set of key records associated with the client and can be coordinated with metadata or indexing mechanisms to ensure completeness and traceability.

Once all relevant keys and tweaks have been successfully re-encrypted with the new master key, the cybersecurity engine 304 may update the client's key registry to mark the new master key as the active encryption root. The old master key may then be securely deleted from storage or memory, or optionally archived with expiration metadata if compliance policies require retention. The completion of the key rotation process may be communicated to the client computing device 12.

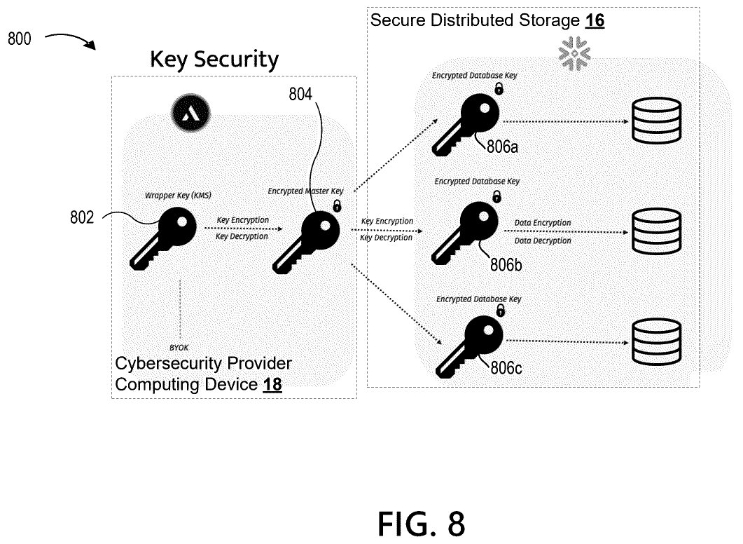

FIG. 8 illustrates the cryptographic key hierarchy and flow 800 involved in cybersecurity provider's secure encryption key management system for the secure distributed storage 16, as previously described. The illustration effectively separates the trust boundary between the cybersecurity provider's secure key management system instance (on the left) and a user's secure distributed environment (on the right), showcasing how keys are securely generated, encrypted, stored, and used without ever exposing plaintext key material to untrusted environments.

On the cybersecurity provider's side, the wrapper key 802 may reside in the key management computing device 14. In Bring-Your-Own-Key (BYOK) scenarios, this wrapper key 802 may be managed and owned by the client at the client computing device 12. The wrapper key 802 may be used to encrypt and decrypt the master key 804, which may be generated and stored by the cybersecurity provider (e.g., via the key management service (e.g., AWS KMS). The master key 804 may act as a central encryption authority, used to encrypt and decrypt individual database keys 806a, 806b, or up to 806c. These encrypted database keys 806a, 806b, or up to 806c are then securely transferred and stored in the client's secure distributed storage environment, as shown in the right-hand section of FIG. 8. Once in the secure distributed storage, each encrypted database keys 806a, 806b, or up to 806c is tied to a specific dataset or partition (e.g., a table or schema), and is used to encrypt and decrypt data at query time.

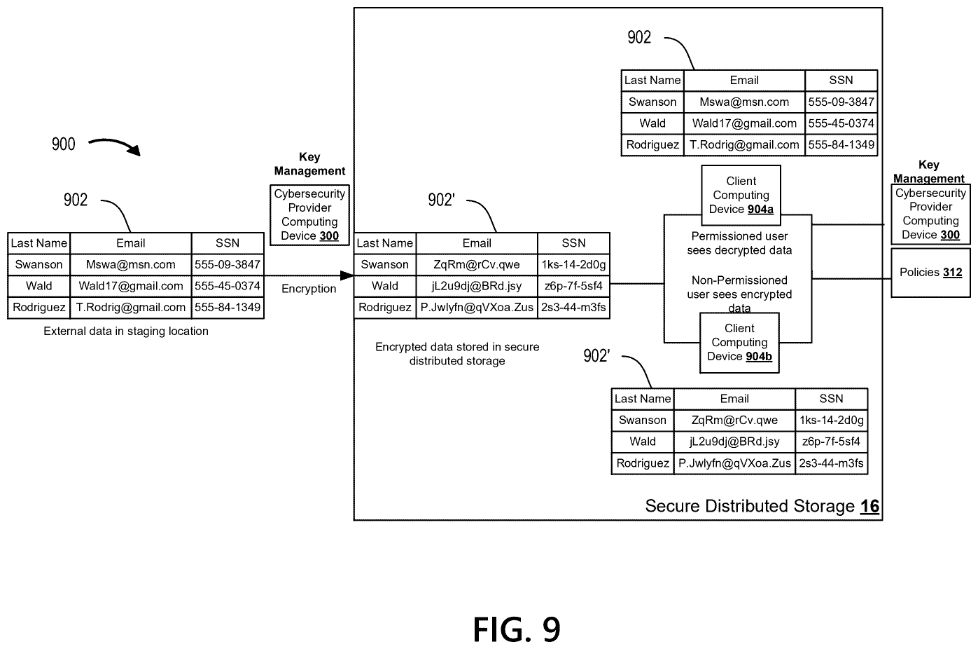

FIG. 9 illustrates a block diagram of transparent decryption 900 discussed above. Transparent decryption may allow users to see encrypted or decrypted data based on the policy set at the policy engine 304a of the cybersecurity engine 304 at the cybersecurity provider computing device 300 by accessing data as the user would if the data was not encrypted. In various embodiments, an external function or other mechanism is used to pass query context to the policy engine 304a from the secure distributed storage 16. The policy engine 304a may then return what level of access the user has. If the user has permission to see the data in plain text, a masking policy logic triggers decryption over the data, which may be according to the encryption key management discussed above. The decrypted data is returned to the user in the query results. If the user does not have permission to see the plain text data, the encrypted data is returned to the user in the query results. This process is not visible to the user, the user simply queries data like they normally would and gets encrypted or decrypted data back. The encrypted and decrypted data may include the format of the data (e.g., character length and pattern).

In the illustrated example, the “Email” and the “SSN” columns of the table 902 may be encrypted by the cybersecurity provider computing device 300 while the “Last Name” column is not encrypted. Table 902'illustrates the encrypted columns. A first user that is associated with a client computing device 904a may make a request for table 902 and a second user that is associated with a client computing device 904b may also make a request for the table 902. The secure distributed storage 16 may query the cybersecurity provider computing device 300 to check the policies 312 to determine whether the first user or the second user have rights in viewing the encrypted data. The cybersecurity provider computing device 300 using the policies 312 may determine that the first user has permission while the second user does not and return the table 902 to the client computing device 904a and return the table 902′ to the client computing device 904b. In other examples, the second user may have permission to view “Email” but not the “SSN.” As such, the secured distributed storage 16 may return decrypted versions of the “Email” column and encrypted versions of the “SSN”column.

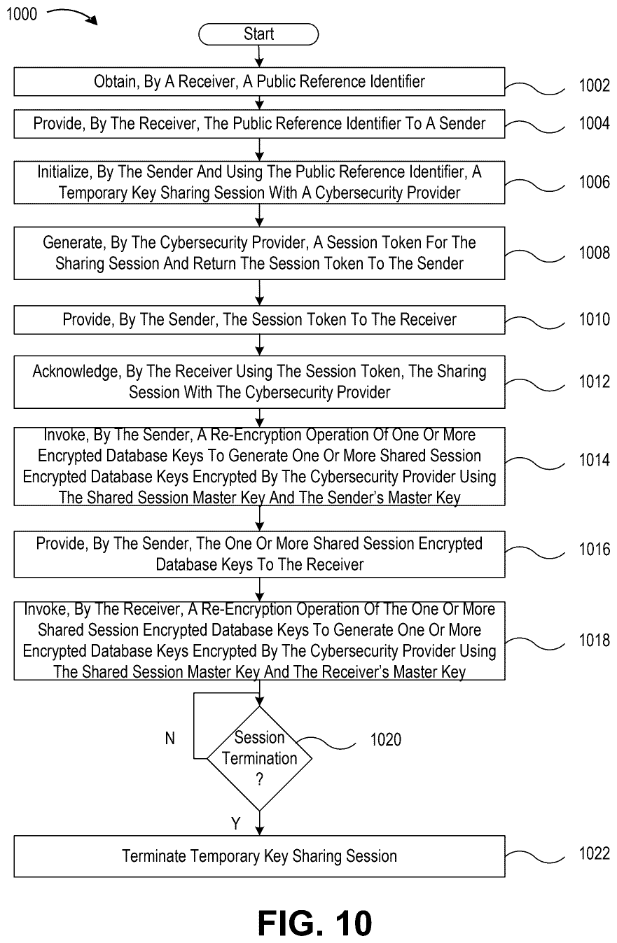

FIG. 10 illustrates a flowchart of a method 1000 for secure encrypted cryptographic key sharing via temporary sessions between two independent computing entities, each operating within separate encryption domains, according to various embodiments of the present disclosure. The method 1000 utilizes a temporary, authenticated key sharing session managed by the cybersecurity provider computing device 300. The cybersecurity provider computing device's 300 FPE key sharing method may enable the use case where a data producer and cybersecurity provider's customer wishes to share encrypted data with a consumer who is also a cybersecurity provider's customer. Using this method 1000, a producer can share the data encryption keys with the consumer so that each party holds their own key to decrypt the FPE data using independent cybersecurity provider deployments. The cybersecurity provider's FPE key management may use a key-wrapping scheme; data keys are encrypted at rest in a client's secure distributed storage account and only decrypted at query-time by a master key held by the cybersecurity provider (or held by the client in the case of a bring-your-own-key deployment). Given that two parties have separate FPE deployments and master keys, the data keys to share must be reencrypted from one master key to another. This is facilitated by establishing a secure temporary sharing session that has a common master key that both parties have access to, and then reencrypting one or more data keys against the session to securely share them outside of a secure communication medium. Before establishing a session, both parties must have a cybersecurity provider instance set up on their secure distributed storage accounts as well as a fully-initialized encryption deployment (e.g., master key is generated). Unless otherwise qualified, all SQL commands may be made with the current database set to the caller's FPE integration database and the current schema set to “key_sharing_handler.”

The method 1000 may begin at block 1002 where a first client computing device that operates as a receiver obtains a public reference identifier. In an embodiment, at block 1002, a user of a first client computing device 200a may make a request for a public reference identifier at the secure distributed storage controller 404. For example, the user may invoke a function call within the secure distributed storage 16 (e.g., get_public_ref_id( )). The public reference identifier may be a universally unique identifier (UUID).

The method 1000 may proceed to block 1004 where the first client computing device provides the public reference identifier to a second client computing device. In an embodiment, at block 1004, the first client computing device 200a may send or transmit the public reference identifier to a second client computing device 200b. The transmission may be over a secure communication channel, such as encrypted email or a secure file transfer mechanism.

The method 1000 may proceed to block 1006 where the second client computing device that operates as a sender initializes a temporary key sharing session by invoking a session initialization command. In an embodiment, at block 1006, the second client computing device 200b may initialize a temporary key sharing session with the cybersecurity provider computing device 300. The temporary key sharing session may be initiated with a session initialization command (e.g., sender_intialize_key_sharing_session) that includes the receiver's public reference identifier and a session time-to-live (TTL) parameter. Specifically, the session sharing engine 304b may obtain the initialization of the temporary key sharing session.

The method 1000 may proceed to block 1008 where a session token is generated and returned to the second client computing device. In an embodiment, at block 1008, the session sharing engine 304b of the cybersecurity provider computing device 300 may generate a session token. By generating a session token, the session sharing engine 304b may establish a loosely-bound sharing session that can only be acknowledged by the receiver (e.g., identified by the public reference identifier). The session sharing engine 304b may generate sharing session master key according to master key generation discussed above. The session sharing engine 304b may return the session token to the second client computing device 200b. The session master key may be internal to the cybersecurity provider computing device 300 and is not visible to either party of the temporary key sharing session.

The method 1000 may proceed to block 1010 where the second client computing device provides the session token to the first client computing device. In an embodiment, at block 1010, the second client computing device 200b may send or transmit the session token to the client computing device 200a. The transmission may be over a secure communication channel, such as encrypted email or a secure file transfer mechanism. The first client computing device 200a/receiver may store the session token in a secure location such as a key store 216a.

The method 1000 may proceed to block 1012 where the first client computing device acknowledges the sharing session. In an embodiment, at block 1012, the first client computing device 200a may acknowledge the sharing session with the session sharing engine 304b. The first client computing device 200a may invoke an acknowledgement procedure (e.g., receiver_acknowledge_key_sharing_session) using the session token. Upon a successful acknowledgement, the sharing session may become mutually bound and authenticated between the sender and the receiver.

After the shared session is established, the method 1000 may proceed to block 1014 where the second client computing device invokes a re-encryption operation of one or more encrypted database keys. In an embodiment, at block 1014, the second client computing device 200b may identify one or more database keys to provide to the first client computing device 200a. For example, the one or more database keys may be associated with (e.g., used to encrypt) particular encrypted data that the sender wants to share with the receiver. The second client computing device 200b may call the session sharing engine 304b with the session token and one or more encrypted database keys. The cybersecurity engine 304 decrypts the encrypted database key with the master key according to methods discussed above (e.g., using a wrapper key to decrypt the master key, etc.). The session sharing engine 304b may then encrypt those decrypted database keys with the sharing session master key to generate one or more shared session encrypted database keys and provide the shared session encrypted database keys back to the sender (e.g., second client computing device 200b). As discussed above, the cybersecurity engine 304 may integrate FPE. As such, encryption may be performed using a key and a related tweak value, both of which are persisted in ciphertext. It should be understood that encrypting and decrypting a database key in method 1000 is a generalization for operating on one or more pairs of keys and tweaks as opposed to a single value.

The method 1000 may proceed to block 1016 where the second client computing device sends the one or more shared session encrypted database keys to the first client computing device. In an embodiment, at block 1016, the second client computing device 200b may send or transmit the shared session encrypted database keys to the client computing device 200a. The sender may optionally modify associated key labels or metadata to conform to external naming conventions or to prevent leakage of internal information. The transmission may be over a secure communication channel, such as encrypted email or a secure file transfer mechanism. The first client computing device 200a/receiver may store the shared session encrypted database keys in a secure location such as the key store 216a.

The method 1000 may proceed to block 1018 where the first client computing device invokes a re-encryption function on the shared session encrypted database keys. In an embodiment, at block 1018, the first client computing device 200a may invoke a second re-encryption function (e.g., receiver_reencrypt_into_client_keychain) with the session sharing engine 304b using the session encrypted database keys and the session token. The session sharing engine 304b may decrypt the shared session encrypted database keys with the session master key that is identified by the session token and re-encrypt the session keys under the receiver's own master key, thereby generating usable key material within the receiver's trust domain. As such, the encrypted database key may be added to the receiver's key store 310 in that user instance 309.

The method 1000 may proceed to decision block 1020 where it is determined whether a session termination condition is present. In an embodiment, at decision block 1020, the session sharing engine 304b may determine whether a session termination condition is present. For example, the session sharing engine 304b may determine whether the TTL condition is satisfied such that the amount of time that the shared session is allowed to be open has lapsed. In other embodiments, the session sharing engine 304b may monitor the first client computing device 200a or the second client computing device 200b for any close session messages. For example, the receiver or the sender may run “call close_key_sharing_session(<session token>).” If, at decision block 1020, a session termination condition is not present, the method 1000 may continue to monitor for a session termination condition.

If the session termination condition is present, then the method 1000 may proceed to block 1022 where the shared session is terminated. In an embodiment, at block 1022, the session sharing engine 304b may tear down or close the session such that no re-encryption will be allowed and the shared session will be inaccessible by the sender and the receiver. An appropriate message may be returned to either the sender or the receiver if a call to re-encrypt is received.

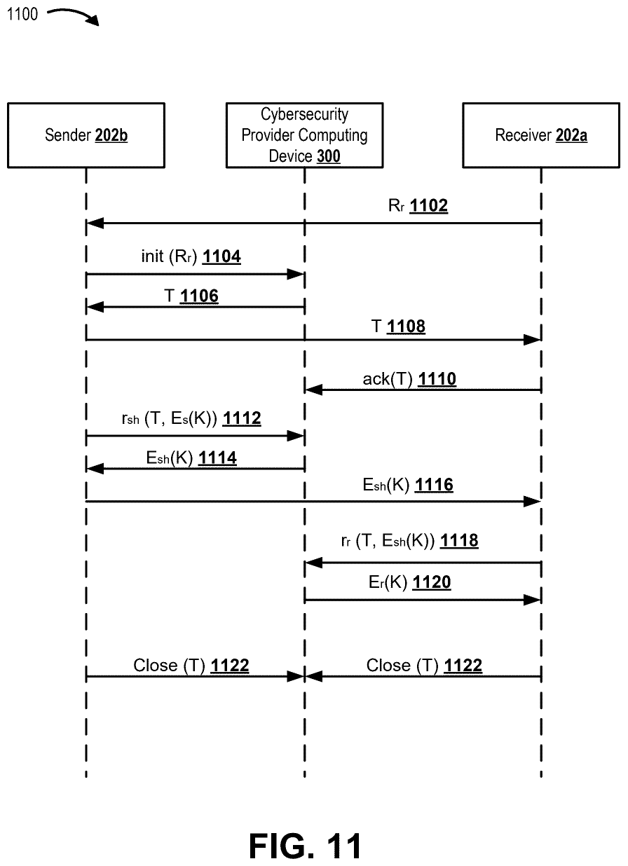

FIG. 11 illustrates a message sequence diagram 1100 illustrating an example of method 1000. In an embodiment, the secure key sharing process of method 1000 is illustrated by the message sequence diagram 1100 that details the interactions between a sender 200b, a receiver 200a, and the cybersecurity provider computing device 300. The process begins when the receiver 200a generates and transmits a public reference identifier “Rr” to the sender 200b, at step 1102. The sender 200b uses the public reference identifier Rr to initialize a key sharing session by invoking an initialization function with the secure platform, at step 1104. In response, the platform generates a session token “T” that uniquely identifies the key sharing session and returns the session token T to the sender 200b, at step 1106. This session token T is transmitted by the sender 200b to the receiver 200a, at step 1108. The receiver 200a then uses the session token T to acknowledge the session with the secure platform (ack(T)), which binds the session to both participants and authorizes subsequent operations, at step 1110. The acknowledgement completes the initial phase of session creation.

Once the session is active, the sender 200b proceeds to initiate key sharing by supplying the session token T and an encrypted database key Es(K). (specifically, a database key previously encrypted using the sender's own FPE master key), at step 1112. The cybersecurity provider computing device 300 decrypts this input database key and re-encrypts it using the session's temporary master key, resulting in an intermediate, shareable encrypted database key Esh(K) that is returned to the sender 200b, at step 1114. This shareable encrypted database key Esh(K) is then transmitted from the sender 200b to the receiver 200a, at step 1116.

Upon receiving the shareable encrypted database key Esh(K), the receiver 200a submits the shareable encrypted database key Esh(K) and the session token T to the cybersecurity provider computing device 300, requesting re-encryption into the receiver's own cryptographic domain, at step 1118. The cybersecurity provider computing device 300 again encrypts the shareable encrypted database key Esh(K) using the session master key and re-encrypts it using the receiver's FPE master key. The final output is a database key Er(K) encrypted under the receiver's key hierarchy, which is then sent to the receiver 200a and stored in the receiver's secure key table for subsequent use, at step 1120. At the conclusion of the process, at least one of the sender or the receiver may terminate the session by invoking a session closure function, which renders the shared session inactive and prevents further re-encryption operations, at step 1122. The entire protocol ensures that no raw key material is exposed to either party, while enabling cryptographically isolated systems to securely exchange usable encryption keys through a transient, authenticated context. As noted above, FPE encryption may be performed using a key and a related tweak value, both of which are persisted in ciphertext. It should be understood that encrypting and decrypting a database key K is a generalization for operating on one or more pairs of keys or tweaks as opposed to a single value.

Thus, the systems and methods of the present disclosure provide a comprehensive framework for secure, scalable, and policy-aware encryption key management and data access control within distributed cloud data environments. Through the use of hierarchical key structures, external function integration, and a temporary session-based key sharing protocol, the disclosed systems and methods enable cryptographically isolated entities to securely exchange encryption keys without exposing raw key material or compromising trust boundaries. The incorporation of format-preserving encryption further allows sensitive data to be protected without altering its structure, thereby preserving schema integrity and application compatibility. Transparent decryption mechanisms, governed by real-time access policies, offer seamless user experiences while enforcing granular data access restrictions. Collectively, these innovations deliver significant technical advantages including reduced key exposure risk, improved regulatory compliance, operational scalability across multi-tenant environments, and simplified integration into existing data workflows. While specific embodiments and examples have been described for illustrative purposes, the scope of the invention encompasses any variations, modifications, and equivalents without departing from the scope of the present disclosure.

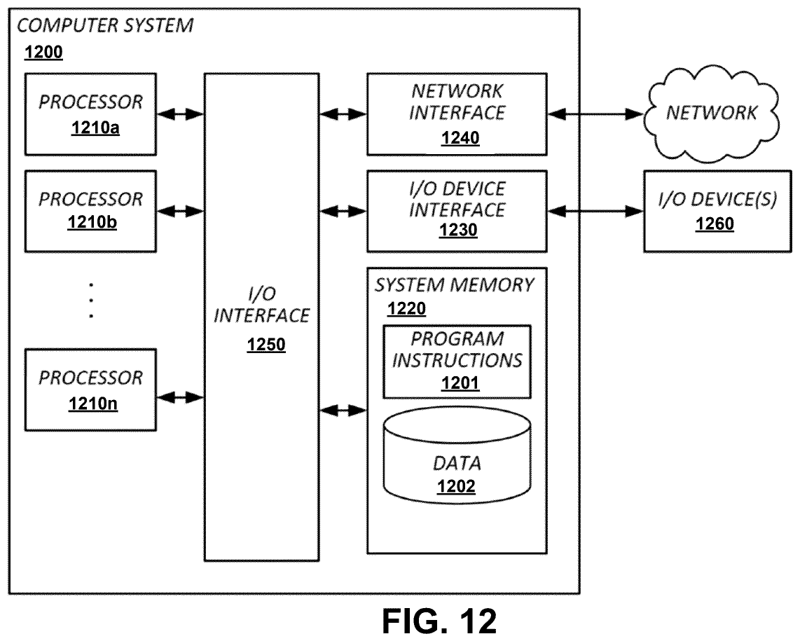

FIG. 12 is a diagram that illustrates an exemplary computing system 1000 in accordance with embodiments of the present technique. Various portions of systems and methods described herein, may include or be executed on one or more computer systems similar to computing system 1200. Further, processes and modules described herein may be executed by one or more processing systems similar to that of computing system 1200.

Computing system 1200 may include one or more processors (e.g., processors 1210a-1210n) coupled to system memory 1220, an input/output I/O device interface 1230, and a network interface 1240 via an input/output (I/O) interface 1250. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1200. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1220). Computing system 1200 may be a uni-processor system including one processor (e.g., processor 1210a), or a multi-processor system including any number of suitable processors (e.g., 1210a-1210n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1200 may include a plurality of computing devices (e.g., distributed computer systems) to implement various processing functions.

I/O device interface 1230 may provide an interface for connection of one or more I/O devices 1260 to computer system 1200. I/O devices may include devices that receive input (e.g., from a user) or output information (e.g., to a user). I/O devices 1260 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1260 may be connected to computer system 1200 through a wired or wireless connection. I/O devices 1260 may be connected to computer system 1200 from a remote location. I/O devices 1260 located on remote computer system, for example, may be connected to computer system 1200 via a network and network interface 1240.

Network interface 1240 may include a network adapter that provides for connection of computer system 1200 to a network. Network interface may 1240 may facilitate data exchange between computer system 1200 and other devices connected to the network. Network interface 1240 may support wired or wireless communication. The network may include an electronic communication network, such as the Internet, a local area network (LAN), a wide area network (WAN), a cellular communications network, or the like.

System memory 1220 may be configured to store program instructions 1200 or data 1210. Program instructions 1200 may be executable by a processor (e.g., one or more of processors 1210a-1210n) to implement one or more embodiments of the present techniques. Instructions 1200 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1220 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1220 may include a non-transitory computer readable storage medium that may have program instructions stored thereon that are executable by a computer processor (e.g., one or more of processors 1210a-1210n) to cause the subject matter and the functional operations described herein. A memory (e.g., system memory 1220) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1250 may be configured to coordinate I/O traffic between processors 1210a-1210n, system memory 1220, network interface 1240, I/O devices 1260, and/or other peripheral devices. I/O interface 1250 may perform protocol, timing, or other data transformations to convert data signals from one component (e.g., system memory 1220) into a format suitable for use by another component (e.g., processors 1210a-1210n). I/O interface 1250 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1200 or multiple computer systems 1200 configured to host different portions or instances of embodiments. Multiple computer systems 1200 may provide for parallel or sequential processing/execution of one or more portions of the techniques described herein.

Those skilled in the art will appreciate that computer system 1200 is merely illustrative and is not intended to limit the scope of the techniques described herein. Computer system 1200 may include any combination of devices or software that may perform or otherwise provide for the performance of the techniques described herein. For example, computer system 1200 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1200 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1200 may be transmitted to computer system 1200 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) can be said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs.

The present techniques will be better understood with reference to the following enumerated embodiments:
Clause 1. A tangible, non-transitory, machine-readable medium storing instructions that, when executed by one or more processors, effectuate operations comprising: generating, by one or more processors, a master encryption key associated with a user of a secure distributed storage comprising a plurality of databases; encrypting, by one or more processors, the master encryption key with a wrapper key that is stored at a key management system associated with a cybersecurity provider; generating, by one or more processors, a database key for encrypting and decrypting data stored in one or more databases of the secure distributed storage; encrypting, by one or more processors, the database key using the master encryption key, thereby generating an encrypted database key; and storing, by one or more processors, the encrypted database key in association with the user at the secure distributed storage.
Clause 2. The machine-readable medium of clause 1, wherein the operations further comprise, in response to a query to access encrypted data: retrieving the encrypted database key from the secure distributed storage and decrypting the encrypted database key using the master encryption key; and using the decrypted database key to decrypt the encrypted data stored in the secure distributed storage.
Clause 3. The machine-readable medium of clause 2, wherein the operations further comprise: decrypting the encrypted data using the decrypted database key and returning a plaintext result to the user in response to the query.
Clause 4. The machine-readable medium of clause 2, wherein the operations further comprise: determining, based on a masking policy evaluated by a policy engine, whether the decrypted data is returned in plaintext or encrypted form.
Clause 5. The machine-readable medium of clause 4, wherein the masking policy is based on at least one of a user identifier, a user role, a data field being accessed, or a resource associated with the user.
Clause 6. The machine-readable medium of clause 1, wherein the master encryption key is decrypted using the wrapper key prior to decrypting the encrypted database key.
Clause 7. The machine-readable medium of clause 1, wherein the wrapper key is provided by the user and is stored at a client computing device in a bring-your-own-key (BYOK) configuration.
Clause 8. The machine-readable medium of clause 1, wherein the database key is generated in response to a function call made through a structured query language (SQL) interface of the secure distributed storage.
Clause 9. The machine-readable medium of clause 8, wherein the function call is executed via an external function interface that transmits a request to the cybersecurity provider.
Clause 10. The machine-readable medium of clause 1, wherein the database key is used with a format-preserving encryption algorithm to encrypt and decrypt data.
Clause 11. The machine-readable medium of clause 10, wherein the format-preserving encryption algorithm is FF3-1.
Clause 12. The machine-readable medium of clause 10, wherein the operations further comprise: using a tweak value in conjunction with the database key as input to the format-preserving encryption algorithm.
Clause 13. The machine-readable medium of clause 12, wherein the operations further comprise: decrypting the tweak value using the master encryption key before using the tweak value as input to the format-preserving encryption algorithm.
Clause 14. The machine-readable medium of clause 1, wherein the database key is associated with a particular type of data selected from the group consisting of social security numbers, credit card numbers, telephone numbers, email addresses, names, and addresses.
Clause 15. The machine-readable medium of clause 1, wherein the database key is associated with data stored across multiple databases or across multiple fields within a database.
Clause 16. The machine-readable medium of clause 1, wherein the encrypted database key is stored in a key store in a user instance associated with the secure distributed storage.
Clause 17. The machine-readable medium of clause 1, wherein the decrypted database key is held only in transient memory of a cybersecurity provider computing device during encryption or decryption operations.
Clause 18. The machine-readable medium of clause 1, wherein the operations further comprise: in response to a request to share the encrypted database key with a second encryption domain, invoking a first re-encryption operation to re-encrypt the encrypted database key using a session master key associated with a temporary key sharing session; transmitting the re-encrypted database key to the second encryption domain; and invoking a second re-encryption operation to re-encrypt the re-encrypted database key using a second master encryption key associated with the second encryption domain.
Clause 19. The machine-readable medium of clause 1, wherein the encrypted data returned to an unauthorized user is in ciphertext but maintains the format of the original data.
Clause 20. A method, comprising: generating, by one or more processors, a master encryption key associated with a user of a secure distributed storage comprising a plurality of databases; encrypting, by one or more processors, the master encryption key with a wrapper key that is stored at a key management system associated with a cybersecurity provider; generating, by one or more processors, a database key for encrypting and decrypting data stored in one or more databases of the secure distributed storage; encrypting, by one or more processors, the database key using the master encryption key, thereby generating an encrypted database key; and storing, by one or more processors, the encrypted database key in association with the user at the secure distributed storage.

What is claimed is:

1. A tangible, non-transitory, machine-readable medium storing instructions that, when executed by one or more processors, effectuate operations comprising:
generating, by one or more processors, a master encryption key associated with a user of a secure distributed storage comprising a plurality of databases;
encrypting, by one or more processors, the master encryption key with a wrapper key that is stored at a key management system associated with a cybersecurity provider;
generating, by one or more processors, a database key for encrypting and decrypting data stored in one or more databases of the secure distributed storage;
encrypting, by one or more processors, the database key using the master encryption key, thereby generating an encrypted database key; and
storing, by one or more processors, the encrypted database key in association with the user at the secure distributed storage.

2. The machine-readable medium of claim 1, wherein the operations further comprise, in response to a query to access encrypted data:
retrieving the encrypted database key from the secure distributed storage and decrypting the encrypted database key using the master encryption key; and
using the decrypted database key to decrypt the encrypted data stored in the secure distributed storage.

3. The machine-readable medium of claim 2, wherein the operations further comprise:
decrypting the encrypted data using the decrypted database key and returning a plaintext result to the user in response to the query.

4. The machine-readable medium of claim 2, wherein the operations further comprise:
determining, based on a masking policy evaluated by a policy engine, whether the decrypted data is returned in plaintext or encrypted form.

5. The machine-readable medium of claim 4, wherein the masking policy is based on at least one of a user identifier, a user role, a data field being accessed, or a resource associated with the user.

6. The machine-readable medium of claim 1, wherein the master encryption key is decrypted using the wrapper key prior to decrypting the encrypted database key.

7. The machine-readable medium of claim 1, wherein the wrapper key is provided by the user and is stored at a client computing device in a bring-your-own-key (BYOK) configuration.

8. The machine-readable medium of claim 1, wherein the database key is generated in response to a function call made through a structured query language (SQL) interface of the secure distributed storage.

9. The machine-readable medium of claim 8, wherein the function call is executed via an external function interface that transmits a request to the cybersecurity provider.

10. The machine-readable medium of claim 1, wherein the database key is used with a format-preserving encryption algorithm to encrypt and decrypt data.

11. The machine-readable medium of claim 10, wherein the format-preserving encryption algorithm is FF3-1.

12. The machine-readable medium of claim 10, wherein the operations further comprise:
using a tweak value in conjunction with the database key as input to the format-preserving encryption algorithm.

13. The machine-readable medium of claim 12, wherein the operations further comprise:
decrypting the tweak value using the master encryption key before using the tweak value as input to the format-preserving encryption algorithm.

14. The machine-readable medium of claim 1, wherein the database key is associated with a particular type of data selected from the group consisting of social security numbers, credit card numbers, telephone numbers, email addresses, names, and addresses.

15. The machine-readable medium of claim 1, wherein the database key is associated with data stored across multiple databases or across multiple fields within a database.

16. The machine-readable medium of claim 1, wherein the encrypted database key is stored in a key store in a user instance associated with the secure distributed storage.

17. The machine-readable medium of claim 1, wherein the decrypted database key is held only in transient memory of a cybersecurity provider computing device during encryption or decryption operations.

18. The machine-readable medium of claim 1, wherein the operations further comprise:
in response to a request to share the encrypted database key with a second encryption domain, invoking a first re-encryption operation to re-encrypt the encrypted database key using a session master key associated with a temporary key sharing session;
transmitting the re-encrypted database key to the second encryption domain; and
invoking a second re-encryption operation to re-encrypt the re-encrypted database key using a second master encryption key associated with the second encryption domain.

19. The machine-readable medium of claim 1, wherein the encrypted data returned to an unauthorized user is in ciphertext but maintains the format of the original data.

20. A method, comprising:
generating, by one or more processors, a master encryption key associated with a user of a secure distributed storage comprising a plurality of databases;
encrypting, by one or more processors, the master encryption key with a wrapper key that is stored at a key management system associated with a cybersecurity provider;
generating, by one or more processors, a database key for encrypting and decrypting data stored in one or more databases of the secure distributed storage;
encrypting, by one or more processors, the database key using the master encryption key, thereby generating an encrypted database key; and
storing, by one or more processors, the encrypted database key in association with the user at the secure distributed storage.
